(19) United States
(12) Patent Application Publication
(10) Pub. No.: US 2014/0217230 A1
(43) Pub. Date: Aug. 7, 2014

(54) DRONE CARGO HELICOPTER

(71) Applicant: Biosphere Aerospace, LLC, Carpinteria, CA (US)

(72) Inventor: Elie Helou, JR., Carpinteria, CA (US)

(73) Assignee: Biosphere Aerospace, LLC, Carpinteria, CA (US)

(21) Appl. No.: 13/759,953

(22) Filed: Feb. 5, 2013

(51) Int. Cl. B64D 9/00

(52) U.S. Cl. CPC B64D 9/003
USPC 244/17.17

(57) ABSTRACT

A drone cargo helicopter having an elongated body. The elongated body has a low profile and has a front portion, a rear portion, an upper surface, a lower surface and a pair of opposing sides extending between the front and the rear portions. At least a first blade set is coupled to the upper surface and rotating in a first direction. Two or more struts are pivotally coupled to opposing sides or lower surface of the elongated body, the struts being coupled via a joint at a top end of the strut. The lower surface of the elongated body comprises a substantially planar surface between the front and rear portions, the substantially planar surface having one or more attachments to provide a rigid engagement with a container. The struts are pivotally movable between a first position and a second position, wherein in the first position, the struts support the elongated body a distance from a ground surface that is greater than a height of the container.

### FIELD OF THE INVENTION

The field of the present invention is cargo aircraft for transporting modular containers, including intermodal containers.

### BACKGROUND

The basic unit for transporting goods has been the truck. Being the basic unit, the truck has defined limitations on intermodal containers that may typically be transported by ships, trains, and trucks. Much of commerce today for which intermodal containers are most convenient are high volume, low weight products, computers being one example. Thus, volume, instead of weight, creates the limiting factor in the design of intermodal containers.

The aforementioned intermodal containers have greatly facilitated and lowered the cost of cargo transportation. However, air cargo, and especially helicopter cargo, has generally been excluded from participation in intermodal cargo systems. In addition, the US military has had increased interest, especially with involvement in countries with little developed infrastructure and high steep mountains, in finding a solution for delivering supplies using vertical landing and takeoff capable aircraft.

The inability of today's aircraft solutions to efficiently integrate with existing intermodal infrastructure has been disadvantageous to international commerce and especially to our military's ability to supply our forward based personnel located in minimal landing areas where vertical take-off and landing capability would be necessary.

### BRIEF SUMMARY

In one embodiment, a drone cargo helicopter is described. The drone helicopter comprises an elongated body having a low profile and comprising a front portion, a rear portion, an upper surface, a lower surface and a pair of opposing sides extending between the front and the rear portions. At least a first blade set is coupled to the upper surface, the first blade set rotating in a first direction. Two or more struts are pivotally coupled to opposing sides or lower surface of the elongated body, the struts being coupled to the elongated body via a joint at a top end of the strut. The lower surface of the elongated body comprises a substantially planar surface between the front and rear portions, the substantially planar surface having one or more attachments to provide a rigid engagement with a container. The struts are pivotally movable between a first position and a second position. In the first position, the struts support the elongated body a distance from a ground surface that is greater than a height of the container. In a second position, the struts lower the elongated body to a distance that is equal to or less than the height of the container.

In accordance with a first aspect of the embodiment, the drone cargo helicopter further comprises a second blade set coupled to the upper surface of the elongated body, the second blade set rotating in a second direction that opposes the first direction of the first blade set.

In accordance with a second aspect of the embodiment, the first and second blade sets are positioned on the elongated body in a side-by-side configuration and have separate axes of rotation.

In accordance with a third aspect of the embodiment, the first and second blade sets are stacked and share a single axis of rotation.

In accordance with a fourth aspect of the embodiment, the struts each further comprises a wheel coupled to a bottom end of the strut.

In accordance with a fifth aspect of the embodiment, the struts each further comprises a hydraulic piston to adjust the distance of the elongated body from the ground surface when the struts are in the first position between a first distance that is greater than the height of the container and a second distance that is equal to or less than the height of the container.

In accordance with a sixth aspect of the embodiment, in the second position, the struts are substantially positioned adjacent and substantially parallel to the sides of the elongated body.

In accordance with a seventh aspect of the embodiment, the drone cargo helicopter further comprises a fuel tank disposed within the elongated body.

In accordance with an eighth aspect of the embodiment, the drone cargo helicopter further comprises a fuel tank disposed externally of the elongated body.

In accordance with a ninth aspect of the embodiment, the attachments provide the rigid engagement between the elongated body and the container along at least four substantially opposing corners of the elongated body. The attachments are preferably provided at repeating intervals along a substantial length and width of the lower surface of the elongated body. In a preferred embodiment, at least four attachments are provided between the elongated body and an individual container and at least four attachments are provided between adjacent containers.

In accordance with a tenth aspect of the embodiment, the drone cargo helicopter further comprises one or both of a forward fairing and an aft fairing coupled to the elongated body at the front portion and the rear portion, respectively. Additional attachments may be provided between either one or both of the forward fairing and the aft fairing, on the one hand, and one or more adjoining containers, on the other hand.

In another embodiment, a drone cargo helicopter is further described. The drone cargo helicopter comprises an elongated body comprising a front portion, a rear portion, an upper surface, a lower surface and a pair of opposing sides extending between the front and the rear portions. At least a first blade set is coupled to the upper surface, the first blade set rotating in a first direction. Two or more telescoping struts coupled to the elongated body, the struts configured to be actuated between a first extended configuration a second retracted configuration. In the first extended configuration, the elongated body is supported at a distance above the ground surface. The lower surface of the elongated body comprises a substantially planar surface between the front and rear portions, the substantially planar surface having one or more attachments to provide a rigid engagement with a container.

In accordance with a first aspect of the embodiment, the struts are coupled to either the opposing sides of the elongated body or the lower surface of the elongated body.

In accordance with a second aspect of the embodiment, in the first extended position, the struts support the elongated body at a distance from the ground that is greater than a height of the container.

In accordance with a third aspect of the embodiment, joints couple the struts to the elongated body. The joints actuate the struts between a first position for actuation of the struts to the first extended configuration and a second position to substantially position the retracted strut adjacent to and substantially parallel the sides of the elongated body for flight.

In accordance with a fourth aspect, the elongated body further comprises an internal cavity between the upper and lower surface of the elongated body. The struts may be retracted into the internal cavity after or simultaneously with actuating the struts to a second position.

In accordance with a fifth aspect, the drone cargo helicopter further comprises one or both of a forward fairing and an aft fairing coupled to the elongated body at the front portion and the rear portion, respectively.

In accordance with a sixth aspect, the drone cargo helicopter further comprises a deployable anti-radar skirt that is configured to cover the peripheral surfaces of a container attached to the elongated body.

In a further embodiment, yet a further drone helicopter is described. The drone cargo helicopter comprises an elongated body comprising a front portion, a rear portion, an upper surface, a lower surface and a pair of opposing sides extending between the front and the rear portions. The lower surface comprises a substantially planar attachment area between the front and rear portions configured to rigidly attach a container. The substantially planar attachment area preferably comprises a plurality of attachment points to couple one or a plurality of containers to the elongated beam. Preferably, the plurality of attachment points are provided at regular or irregular intervals to permit the coupling of a variety of different containers. At least two blades are coupled to the upper surface, the two blades rotating in opposing directions. Two or more struts are coupled to either one of the lower surface or the opposing sides of the elongated body, the struts being actuated between a first position and a second position, wherein in the first position, the struts support the elongated body above a ground surface to receive and rigidly attach one or more containers and wherein in the second position, the struts are either telescopically retracted or pivotally positioned adjacent to and substantially parallel to the sides of the elongated body.

In accordance to a first aspect, the attachment area comprises attachments configured attach the container along at least four corners of the attachment area.

Other objects, features and advantages of the described preferred embodiments will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

Preferred and non-limiting embodiments of the inventions may be more readily understood by referring to the accompanying drawings in which:

FIG. 1 is a perspective view of an embodiment of a drone cargo helicopter with an attached container in which the struts in a first position for landing and/or ground transportation.

FIG. 2 is a perspective view of an embodiment of the drone cargo helicopter of FIG. 1 with the struts in a second position for air flight.

FIG. 3 is a front view of the drone cargo helicopter of FIG. 2.

FIG. 4 is a perspective view of the drone cargo helicopter without the container in which the struts are in a second position for air flight.

FIG. 5 is a perspective view of the drone cargo helicopter of FIG. 4 in which the struts are in a first position for landing and/or ground transportation.

FIG. 6 illustrates the loading of the cargo container from a truck to the drone helicopter.

FIG. 7 is a front view of the drone helicopter of FIG. 4.

FIG. 8 is a perspective view of another embodiment of a drone helicopter having a pair of coaxial rotating blades in which the struts are in a second position for air flight.

FIG. 9 is a front view of the drone helicopter of FIG. 8.

FIG. 10 is a top view of the drone helicopter of FIG. 8.

FIG. 11 is a perspective view of the drone helicopter of FIG. 8 in which the struts are in a first position for landing and/or ground transportation.

FIG. 12 is a perspective view of the drone helicopter of FIG. 8 loaded with a container.

FIG. 13 is a perspective view of an embodiment of the drone helicopter of FIG. 12 with external fuel tanks.

FIG. 14 is a side view of the drone helicopter of FIG. 13.

FIG. 15 is a perspective view of a further embodiment of a drone helicopter configured for attaching a plurality of cargo containers with the struts in a second position for air flight.

FIG. 16 is a top view of the drone helicopter of FIG. 15.

FIG. 17 is a front view of the drone helicopter of FIG. 15.

FIGS. 18-22 show the sequence of steps for loading a plurality of containers onto the drone helicopter of FIG. 15 for air flight transportation.

FIG. 23 is another embodiment of the drone cargo helicopter comprising three struts in a first position for landing and/or ground transportation.

FIG. 24 show the drone cargo helicopter of FIG. 23 in a first configuration for landing and/or ground transportation.

FIG. 25 show the drone cargo helicopter of FIG. 23 in a second configuration for air flight.

FIGS. 26-27 is a perspective view of another embodiment of a drone helicopter comprising three struts, in which the front strut is pivotally movable at a position along its length between a deployed and retracted position.

FIG. 28 is a perspective view of the drone cargo helicopter of FIG. 23 in which the three struts are in a second position for air flight.

FIG. 29 is a perspective view of another embodiment of a drone helicopter comprising a plurality of telescoping struts in a first position for landing and/or ground transportation.

FIG. 30 is a perspective view of the drone helicopter of FIG. 29 with the telescoping struts in a second position for air flight.

FIG. 31 is a perspective views of a further embodiment of the drone helicopter comprising a plurality of telescoping struts in a second position which are further pivotally actuated to the sides of the elongated beams.

FIG. 32-33 show how the drone helicopter of FIG. 31 may couple or detach from the container without deployment of the struts.

FIG. 34 is a front view of a stealth drone helicopter.

FIG. 35 is a top view of the stealth drone helicopter of FIG. 34.

FIG. 36 is a top perspective view of the stealth drone helicopter of FIG. 34.

FIG. 37 is a bottom perspective view of the stealth drone helicopter of FIG. 34 with the struts in a retracted position.

FIGS. 38-39 are bottom perspective views of the stealth drone helicopter of FIG. 34 showing the deployment of the telescoping landing gear from the lower surface of the elongated beam.

FIGS. 40-42 are perspective views showing the sequence of events from the stealth drone helicopter coupling the container with the landing gear in a first position to flight with the landing gear in a second retracted position.

FIG. 43 is a front view of the stealth drone helicopter of FIG. 42.

FIG. 44 is a side view of the stealth drone helicopter of FIG. 42.

FIG. 45 is a bottom view of the stealth drone helicopter of FIG. 42.

FIG. 46 is a front view of the stealth drone helicopter of FIG. 42 with an anti-radar skirt that covers the periphery of the coupled container.

FIG. 47 is a perspective view of another embodiment of a drone cargo helicopter in which the struts and the wheels are actuated between an extended and retracted position to increase and decrease the height of the elongated body relative to the ground surface to permit the coupling of a container.

FIG. 48-49 are side views of another embodiment of a drone cargo helicopter in which the landing gear is retracted from a first position to a second position in the direction of flight.

Like numerals refer to like parts throughout the several views of the drawings.

### DETAILED DESCRIPTION OF THE PREFERRED EMBODIMENTS

Specific, non-limiting embodiments of the present invention will now be described with reference to the drawings. It should be understood that such embodiments are by way of example only and merely illustrative of but a small number of embodiments within the scope of the present invention. Various changes and modifications obvious to one skilled in the art to which the present invention pertains are deemed to be within the spirit, scope and contemplation of the present invention as further defined in the appended claims.

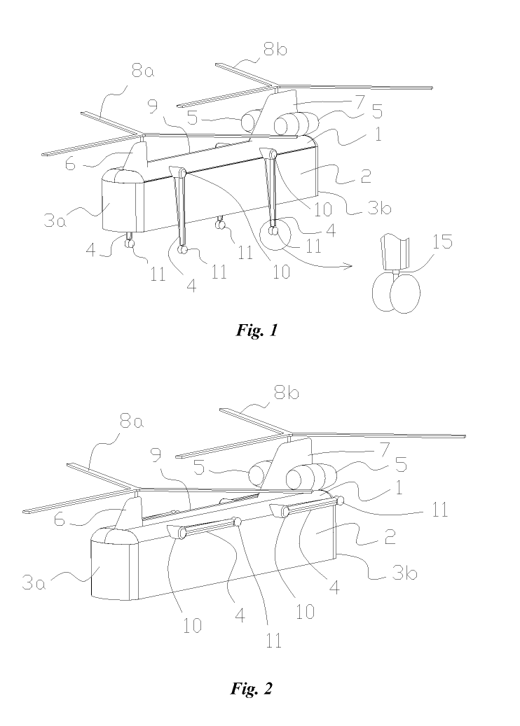

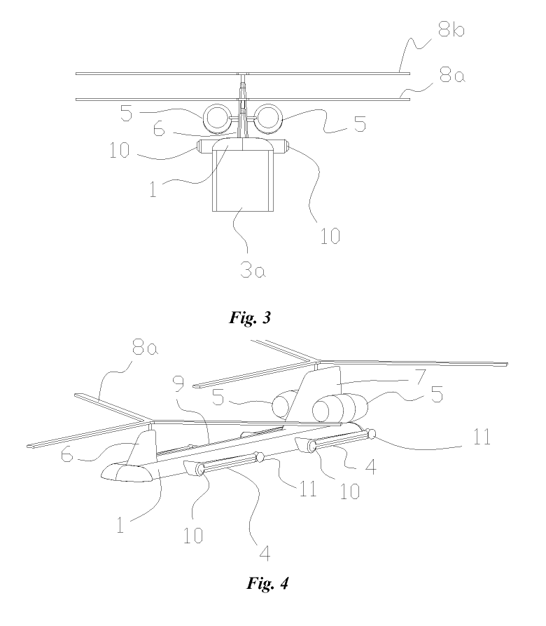

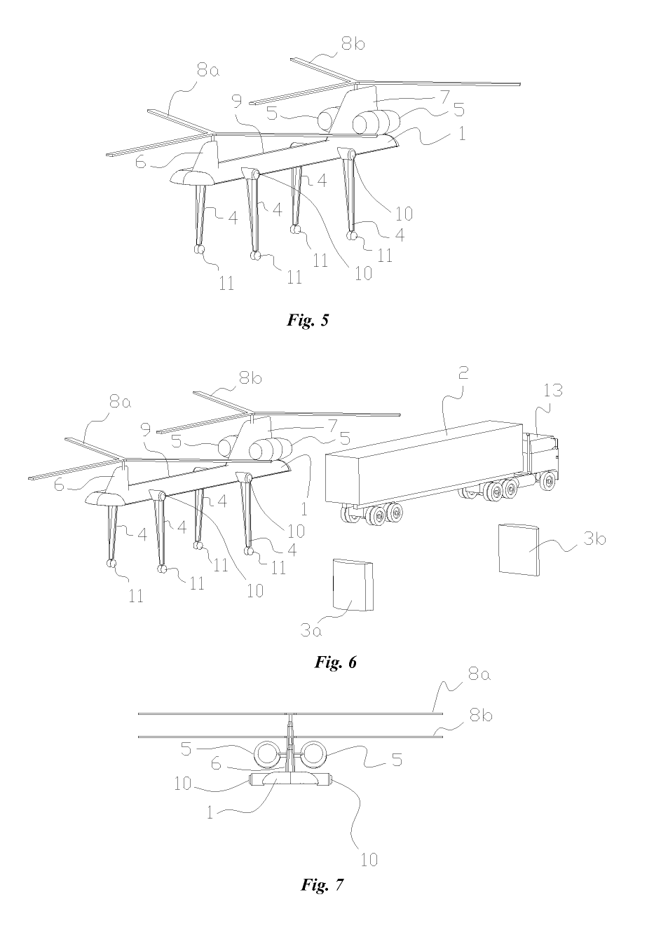

FIGS. 1-7 show one embodiment of a drone cargo helicopter. The drone cargo helicopter comprises an extremely low-profile and elongated body 1 to which all of the main components of the helicopter and the cargo container 2 are coupled.

The elongated body 1 preferably comprises at least two pairs of opposing sides and has a dimension in which its length is at least 2 to 5 times its width. The elongated body 1 is further preferably low-profile, in which the height, as defined by the largest distance between its upper and lower surfaces, are no greater than its length and preferably no greater than its width and, most preferably, no greater than half of its width. In accordance with one embodiment, the elongated body 1 may be constructed in the same manner as the beam structure described in U.S. Pat. No. 7,261,257, issued Aug. 28, 2007, the entire contents of which are incorporated by reference as if fully set forth herein.

In a most preferred embodiment, the elongated body 1 has a lower surface that is at least substantially, if not completely, planar. Because the drone cargo helicopter does not require a cockpit or other structure to separately house a pilot, the elongated body 1 may take on the low profile as depicted in the figures. The controls for the drone cargo helicopter are housed either entirely or substantially entirely within the internal cavity of the elongated body 1 as defined between the upper and lower surfaces. In an alternative embodiment the controls for the drone cargo helicopter may be provided within the forward and/or aft fairings 3a, 3b.

In flight, the elongated body 1, when unloaded with a container, does not have any structures that protrude substantially below the plane that is defined by its lower surface. Thus when unloaded, the elongated body provides an extremely light weight and aerodynamic structure. A planar attachment area is provided as a defined area of the lower surface of the elongated body 1 that is between the forward fairing 3a and the aft fairing 3b. In embodiments where a forward fairing 3a and an aft fairing 3b is not provided, the planar attachment area is comprised of the entire lower and planar surface of the elongated body 1. The attachment area is the area on the lower surface which couples with the container 2. The forward and aft fairings 3a, 3b are optional and detachable structures which may be used for long distance flights.

The drone cargo helicopter may be operated remotely or piloted using an autonomous system. All drones are unmanned because a pilot is not present in the aircraft and are primarily in usage among the world's militaries, where they perform a variety of tasks. The drone may be operated in at least two ways. Either a pilot operates the aircraft remotely, either using line of sight communication with the aircraft or inside a communications center which may be anywhere in the world, or the aircraft is programmed with information which allows it to fly on its own. In latter case, the aircraft may be given a specific flight route to follow or it may be given a particular target, with the aircraft using its programming to reach the destination. The drone aircraft may also have sophisticated programming to allow the on-board controller to make snap judgments in the air to respond to emerging situations.

In a preferred embodiment, the drone cargo helicopter has a dual capability manual and automated mode. As indicated above, in the manual mode, an operator may control the drone either in proximity or at a remote location. The drone cargo helicopter would preferably comprise numerous cameras, laser range sensing systems and other sensors disposed throughout the elongated body 1 in order to provide information regarding location, flight conditions, distances, etc.

In one example, the operator may build the entire mission on the computer by designating the location of the container and the desired destination for the container. The container may be fitted with sensors which indicate its location and also which indicate the location of its attachment points to which the drone cargo helicopter must align and mate with to structurally integrate the container to various attachment points disposed on the lower surface of the elongated beam 1. Once the entire mission is programmed, the electronic controller residing within the drone cargo helicopter travels to and positions itself to the location of the cargo container to be picked up. After the coupling of the elongated beam 1 to the cargo container, which may be performed either manually or automatically, the drone cargo helicopter flies to its programmed destination and releases the cargo container.

Typical containers which are suitable for attachment to and transportation by the drone cargo helicopter include the standard intermodal containers which are in common use by the freight industry. The elongated body 1 is configured specifically with respect to the weights and dimensions of particular types or a range of particular types of intermodal containers. The most common weights and dimensions are described below:

TABLE 1
Dimensions and Weights of Common Intermodal Containers

| | | | | | | 40′ high-cube | | 45′ high-cube | |
|---|---|---|---|---|---|---|---|---|---|
| | | 20′ container | | 40′ container | | container | | container | |
| | | imperial | metric | imperial | metric | imperial | metric | imperial | metric |
| external | length | 19′ 10½″ | 6.058 m | 40′ 0″ | 12.192 m | 40′ 0″ | 12.192 m | 45′ 0″ | 13.716 m |
| dimensions | width | 8′ 0″ | 2.438 m | 8′ 0″ | 2.438 m | 8′ 0″ | 2.438 m | 8′ 0″ | 2.438 m |
| | height | 8′ 6″ | 2.591 m | 8′ 6″ | 2.591 m | 9′ 6″ | 2.896 m | 9′ 6″ | 2.896 m |
| interior | length | 18′ 8 13/16″ | 5.710 m | 39′ 5 45/64″ | 12.032 m | 39′ 5″ | 12.000 m | 44′ 4″ | 13.556 m |
| dimensions | width | 7′ 8 19/32″ | 2.352 m | 7′ 8 19/32″ | 2.352 m | 7′ 7″ | 2.311 m | 7′ 8 19/32″ | 2.352 m |
| | height | 7′ 9 57/64″ | 2.385 m | 7′ 9 57/64″ | 2.385 m | 8′ 9″ | 2.650 m | 8′ 9 15/16″ | 2.698 m |
| door | width | 7′ 8⅛″ | 2.343 m | 7′ 8⅛″ | 2.343 m | 7′ 6″ | 2.280 m | 7′ 8⅛″ | 2.343 m |
| aperture | height | 7′ 5¾″ | 2.280 m | 7′ 5¾″ | 2.280 m | 8′ 6″ | 2.560 m | 8′ 5 49/64″ | 2.585 m |

| | | | | | | | | |
|---|---|---|---|---|---|---|---|---|
| volume | 1,169 ft³ | 33.1 m³ | 2,385 ft³ | 67.5 m³ | 2,660 ft³ | 75.3 m³ | 3,040 ft³ | 8.61 m³ |
| maximum | 66,139 lb | 30,400 kg | 66,139 lb | 30,400 kg | 68,008 lb | 30,848 kg | 66,139 lb | 30,400 kg |
| gross weight | | | | | | | | |
| empty weight | 4,850 lb | 2,200 kg | 8,380 lb | 3,800 kg | 8,598 lb | 3,900 kg | 10,580 lb | 4,800 kg |
| net load | 61,289 lb | 28,200 kg | 57,759 lb | 26,600 kg | 58,598 lb | 26,580 kg | 55,559 lb | 25,600 kg |

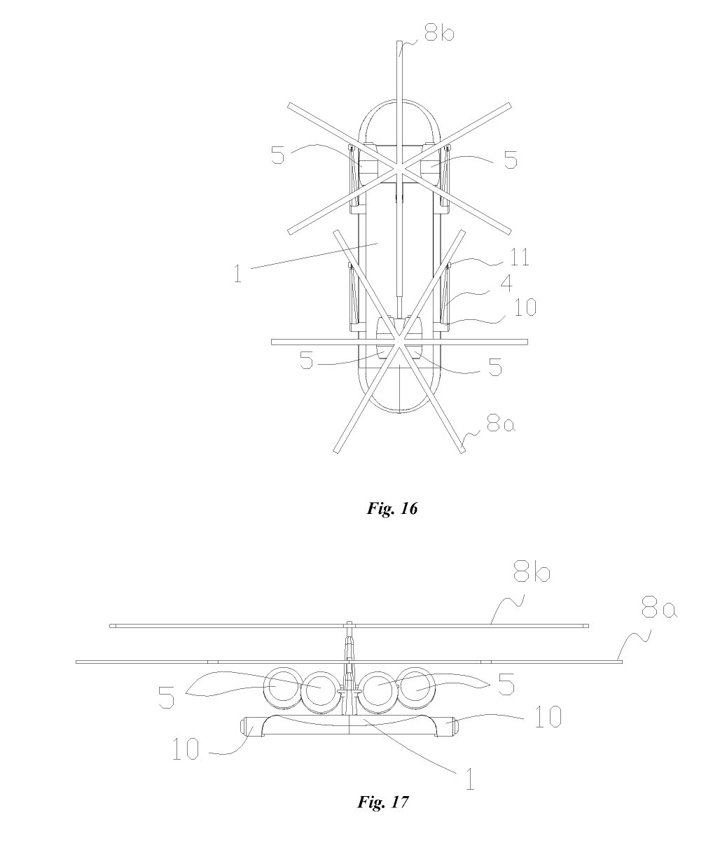

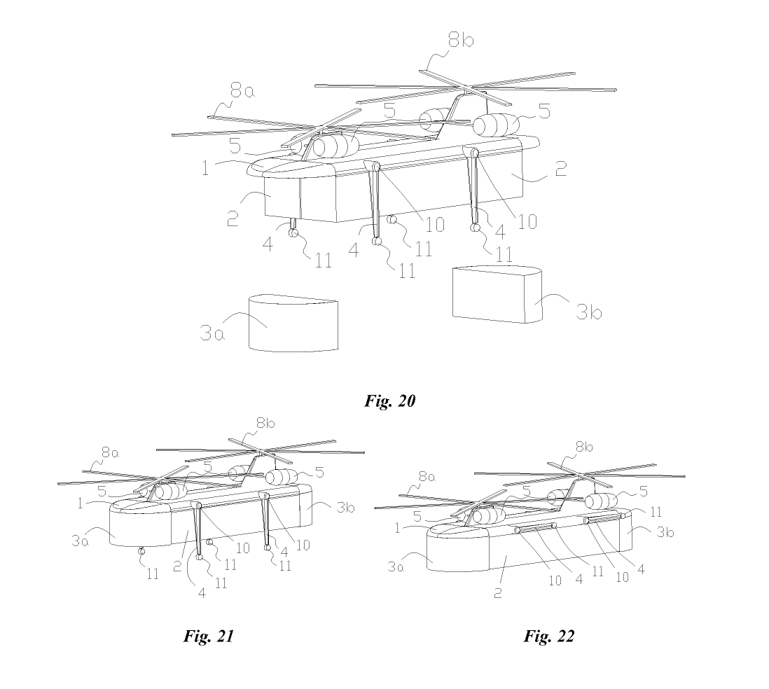

While it is understood that the elongated beam 1 may be configured to accommodate a range of container dimensions, the elongated beam 1 is preferably configured such that at least its width roughly corresponds to the width of a single container (see, e.g., FIGS. 1-3) or the combined widths of the containers (see, e.g., FIGS. 15-22) that it is intended to transport. Additionally, the elongated beam 1 is made of a light weight construction required only to support the weight of the unloaded drone cargo helicopter in flight. The structure that is needed to support the weight of the drone cargo helicopter, loaded with the container(s), is provided by integrating the container(s) to the elongated beam 1 to supplant and provide the structural strength needed to support the loaded drone cargo helicopter.

To that end, the containers must not only be equipped with the appropriate attachments to rigidly and structurally engage and integrate with adjacent containers and to the elongated body, the containers must each further comprise either a rigid frame or be made of a rigid material that is sufficient to not only support the weight of its contents but to also share in the flight load.

A pair of counter-rotating blades 8a, 8b are coupled to the elongated body via a front hub 6 and an aft hub 7. The front and aft hubs 6, 7 support the counter-rotating blades 8a, 8b at staggered heights such that the counter-rotating blades 8a, 8b will not interfere with one another. Front hub 6, which supports the blades 8a, has a lower height than the aft hub 7, which supports blades 8b. This staggered arrangement permits the counter-rotating blades 8a, 8b to be positioned more closely together than if the blades 8a, 8b were provided along the same horizontal plane. In the latter arrangement, the counter rotating blades 8a, 8b would need to be separated at a distance that is greater than the combined length of the longest blades of 8a and 8b.

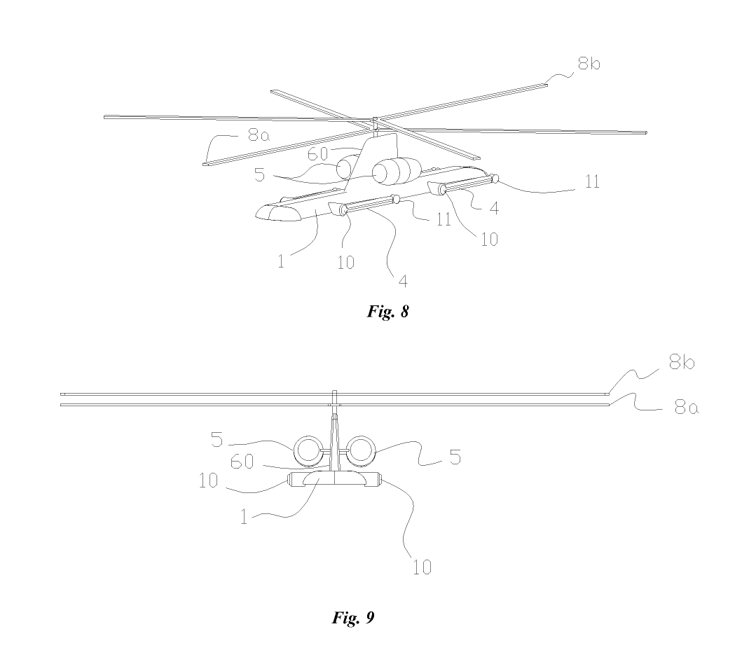

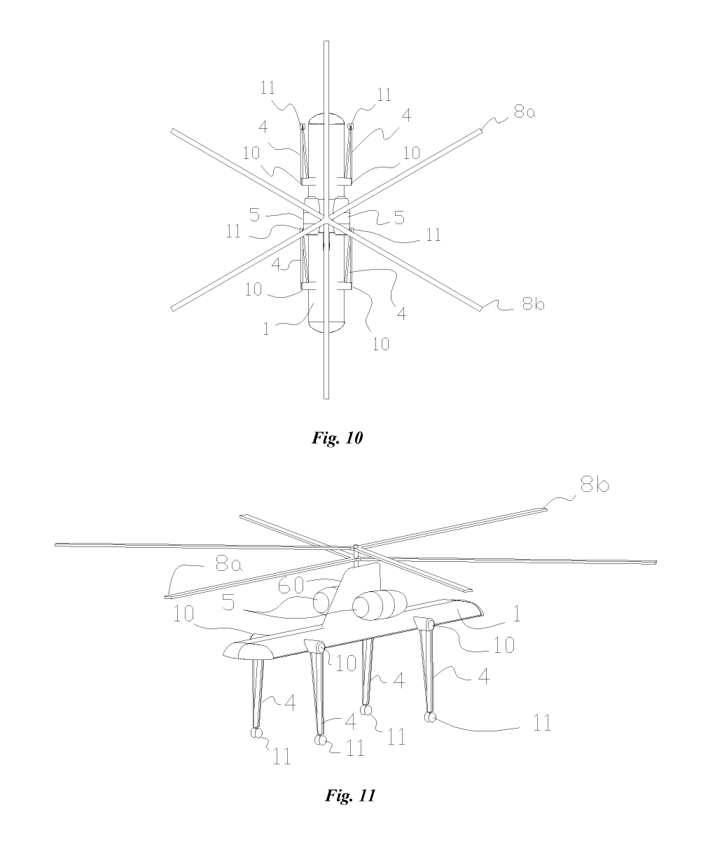

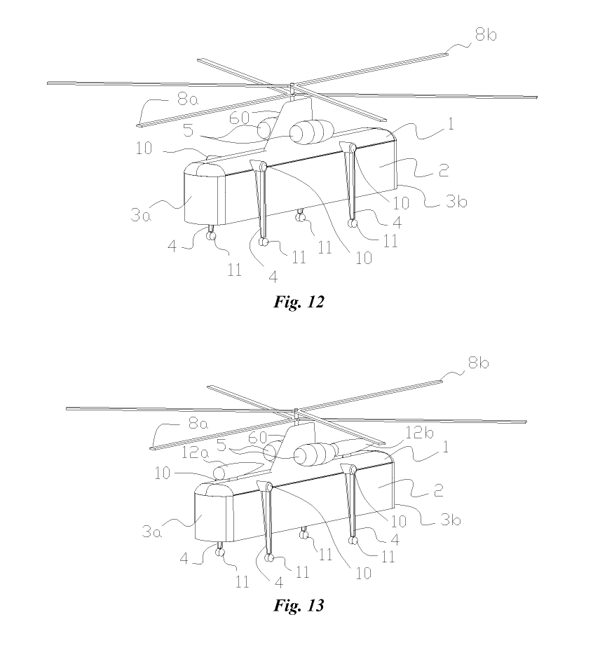

FIGS. 8-12 depict an alternative embodiment of the cargo helicopter in which the pair of counter-rotating blades 8a, 8b are coaxially coupled to a single hub 60 as shown in FIGS. 8-12. This configuration may be desirable where a more compact cargo helicopter (e.g., having a shorter length) is desired. For example, a more compact cargo helicopter may be desired to carry individual units of the smaller intermodal containers (e.g., 20 vs. 40 linear feet).

Referring back to FIGS. 1-7, one or more engines 5 may be coupled to either one or both of the elongated body 1 and the front or aft hubs 6, 7. FIGS. 1-7 show a pair of engines 5 coupled to the aft hub 7 and a transmission rod 9 that transports the power to the front hub 6 and thus to the rotating blades 8a supported thereon.

Fuel storage is preferably provided within the cavity defined by the upper and lower surface of the elongated beam 1 (not shown). The fuel storage may be configured to substantially distribute the weight of the fuel along the length of the elongated body 1. Preferably, the fuel storage may be provided at a single location that roughly corresponds to the center of gravity for the cargo helicopter when it is not loaded with the container 2.

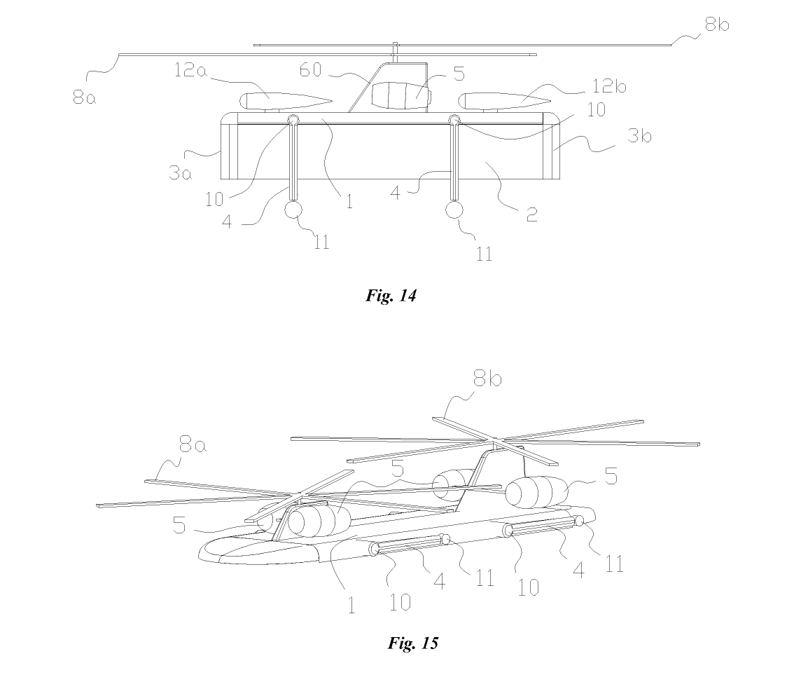

Additional fuel storage may also be provided externally of the elongated beam 1, as shown in FIGS. 13-14. External fuel tanks 12a, 12b may be provided at the forward and aft locations, respectively, of the elongated body 1. In a preferred embodiment, the rate of fuel consumption from the forward and aft fuel tanks 12a, 12b is substantially the same during operation so as to ensure that the center of gravity for the cargo helicopter is not significantly changed. Additional fuel storage may also be provided in the container 2, with the cargo helicopter providing the fuel connections to the fuel storage.

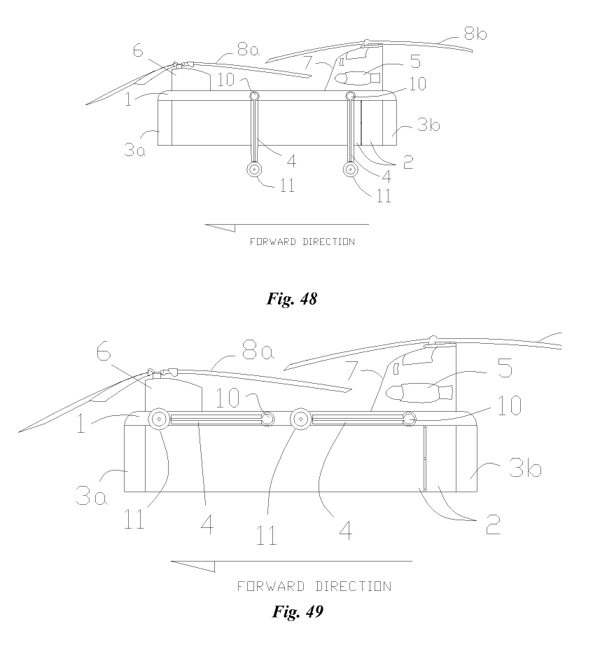

Struts 4 are pivotally coupled to the elongated body 1 via joints 10 that articulate the struts between a first position (FIGS. 1, 5 and 6) for landing and/or ground transportation of the cargo helicopter and a second position (FIGS. 2-4) for air flight. The struts may be pivoted in the direction of travel, as depicted in FIGS. 2-4 or in an opposing direction of travel, as depicted in FIGS. 48-49. The struts each further comprise a wheel assembly 11. In the first position, the struts 4 have a length that permits the elongated body 1 to be supported at a distance from the ground that corresponds to or is greater than the height of the cargo container 2. In one preferred embodiment, a telescoping member 15 is provided between the strut 4 and the wheel assembly 11 to lengthen the entire distance between the beam 1 and wheel assemblies 11 in the first position (See also FIG. 47). The telescoping member 15 may be hydraulically actuated to further lift the beam 1 above the ground and thus to permit the cargo helicopter to accept a cargo container 2 underneath the lower surface of the elongated body 1 as shown in FIGS. 6 and 47 as it is transported by a truck 13.

In one preferred embodiment, the wheel assembly 11 are connected to the struts 4 in a manner which permits the wheels to be rotated around the general axis of the struts independently of one another. In another preferred embodiment, the rotation of the wheels of the wheel assembly 11 may each be powered or controlled remotely independently of the others. In the embodiment where the wheel is powered or motorized, the power may be supplied by a separate auxiliary power. This would permit improved maneuverability of the drone cargo helicopter useful in positioning it relative to the container prior to attachment and to align the attachment points disposed on the elongated beam 1 relative to those on the container. This would also obviate the need for a separate tug to transport the drone helicopter.

As indicated above, forward and aft fairings 3a, 3b may optionally be provided for long-distance transportation of cargo containers 2. The forward and aft fairings 3a, 3b are configured to increase the aerodynamic performance of the cargo helicopter. In a preferred embodiment, the dimensions of the facing surfaces of the forward and aft fairings 3a, 3b and the container 2 roughly correspond to one another. The fairings 3a, 3b may be either stand-alone structures that are attached to one or both of the elongated body 1 and the container 2 or they may be deployed from lower surface of the body 1 itself. The fairings 3a, 3b may be pressurized flexible systems or semi-flexible systems with a deployable skeleton and outer skin. Although the cargo helicopter and container assembly may fly without the fairings 3a, 3b, it is preferable to deploy or attach the fairings 3a, 3b to improve overall flight performance and aerodynamic qualities of the helicopter.

It is understood that either one or both of the forward and aft fairings 3a, 3b may be deployable and/or retractable from within the elongated body 1. In this embodiment, the elongated body 1 would be understood to have an internal cavity and mechanism for storing and deploying the forward and aft fairings 3a, 3b. In another embodiment, the forward and aft fairings 3a, 3b, may be externally attachable and/or removable from the elongated body 1. The detachable forward and aft fairings 3a, 3b may be disposable.

FIGS. 15-22 depict another embodiment of the cargo helicopter configured to couple with and transport a plurality of containers 2. In order to accommodate the plurality of containers 2, the elongated body 1 is provided with a greater width than as shown in FIGS. 1-14.

While the cargo helicopter depicted in these figures are configured to couple two containers 2, it is understood that any number of containers and thus different configurations may be accommodated. In such embodiments, it is preferable to provide a plurality of different attachment points to the elongated body 1. Various ways to attach or structurally mount the container(s) 2 to the elongated body 1 is provided and described in U.S. Pat. No. 7,261,257, issued Aug. 28, 2007, the entire contents of which are incorporated by reference as if fully set forth herein. Additionally, it is further preferable to provide a plurality of modular container units of various sizes that are configured to structurally mate with one another to create an integrated container assembly that is rigidly coupled to the lower surface of the elongated body. The manner of coupling a plurality of containers 2 to one another and to the elongated body 1 is described in U.S. Patent Pub. No. 2010/0276538, published Nov. 4, 2010, the entire contents of which are incorporated by reference as if fully set forth herein.

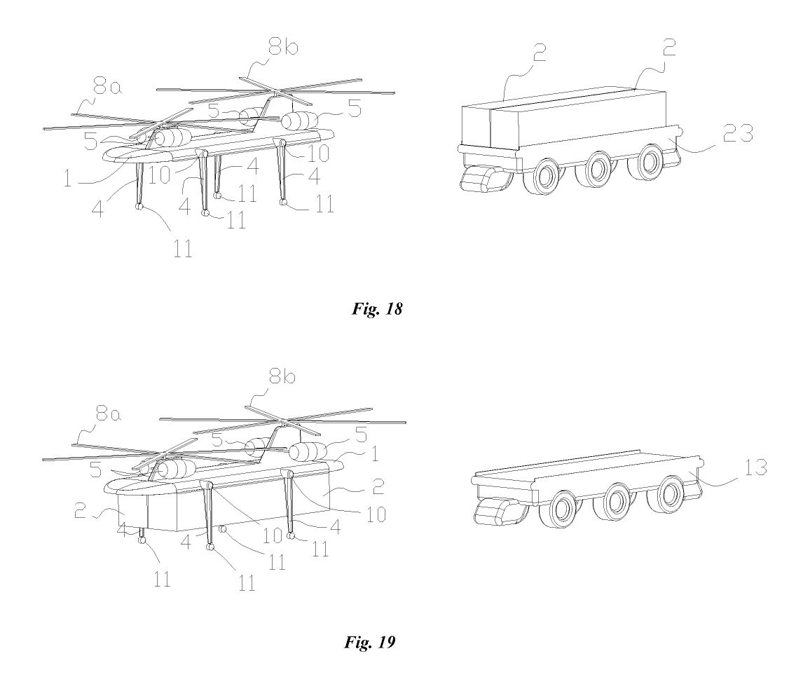

Engines 5 may be provided adjacent the forward and aft hubs to provide the additional power required to transport the additional load represented by the plurality of containers 2. Moreover, inasmuch as the plurality of containers 2 are preferably coupled to one another to provide an integrated structural unit having a center of gravity within a desired range, a specialized ground container cart 23 may be provided to transport the integrated plurality of containers 2 to the lower surface of the elongated body 1. In accordance with one embodiment, once the containers 2 are appropriately positioned underneath the lower surface of the elongated body, the telescoping struts (not shown) may retract to bring the elongated body 1 downward towards the containers 2 and permit the structural attachment between the elongated body 1 and the containers 2 (FIGS. 18-19).

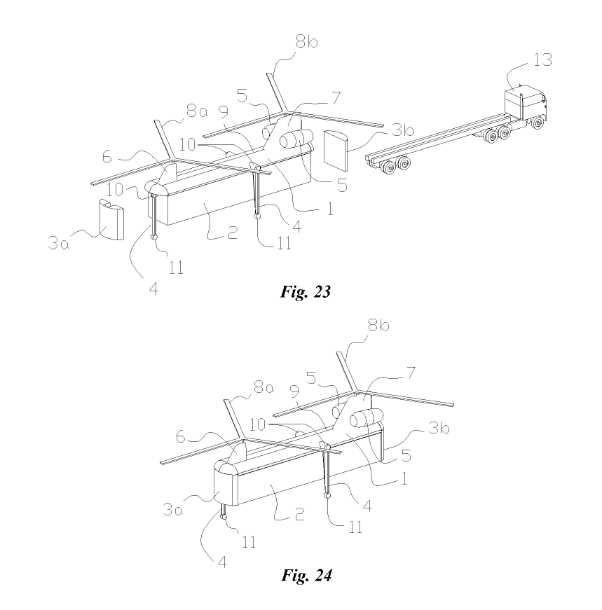

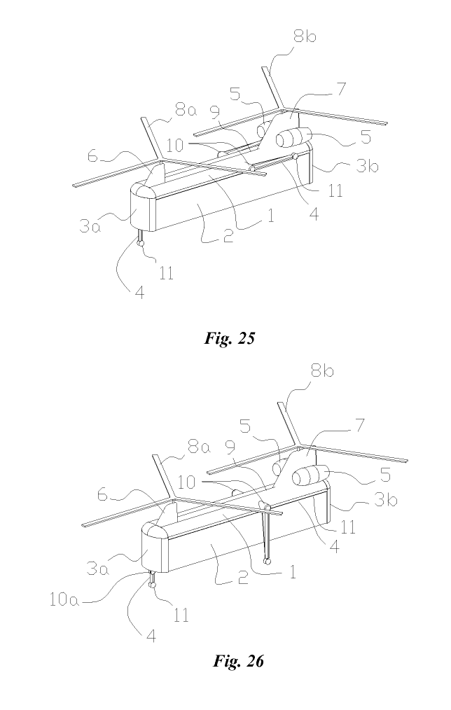

FIGS. 23-28 depict alternative embodiments of the cargo helicopter comprising three struts or landing gear assemblies.

In the embodiment depicted in FIGS. 23-25 and 28 the cargo aircraft comprises a forward strut coupled to the lower surface of the front portion of the elongated body 1. As depicted in FIG. 23, the forward fairing 3a may be configured with a recess to accommodate the forward strut when the forward facing 3a is coupled to the cargo helicopter and container 2. In a first position, the struts 4 support the elongated body 1 above the ground (FIG. 24). In a second position for flight, in which the cargo helicopter does not include the container 2, all of the struts 4 are pivotally actuated such that the struts 4 are substantially parallel to the planar attachment area. The cargo aircraft of FIGS. 23-25 and 28 further define a third position for flight, in which the cargo container is coupled to the container 2, wherein only the side struts 4 are pivotally actuated such that the side struts are substantially parallel to the planar attachment area while the front strut remains in the deployed position.

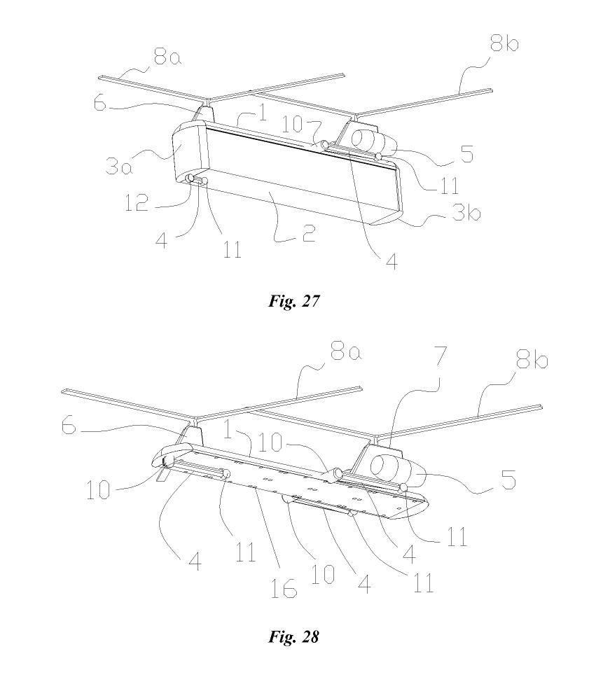

In the alternate embodiment depicted in FIGS. 26-27, the forward strut 4 comprises a pivot adjacent the bottom of the forward aft 3a that permits the forward strut 4 to pivot between a first position for landing and/or ground transportation and second position for flight.

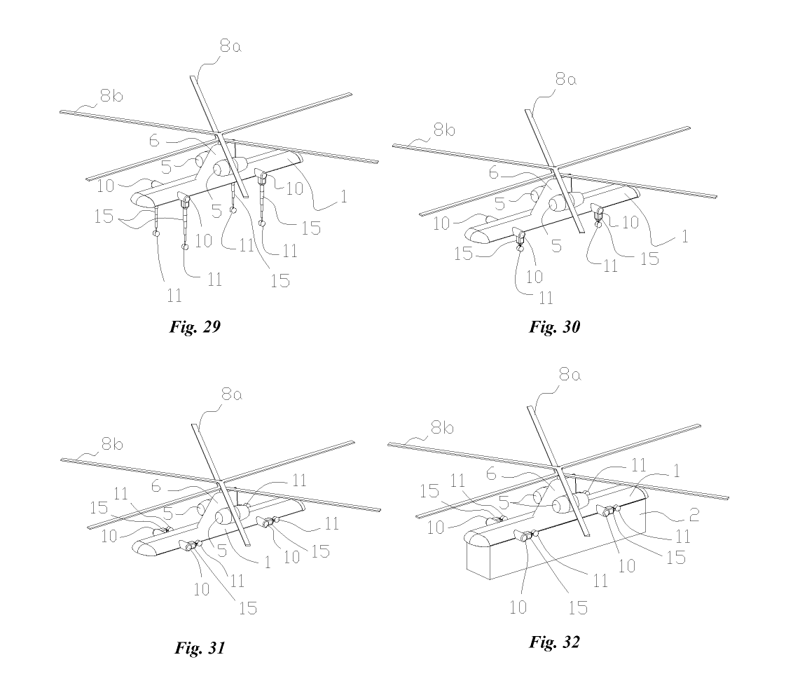

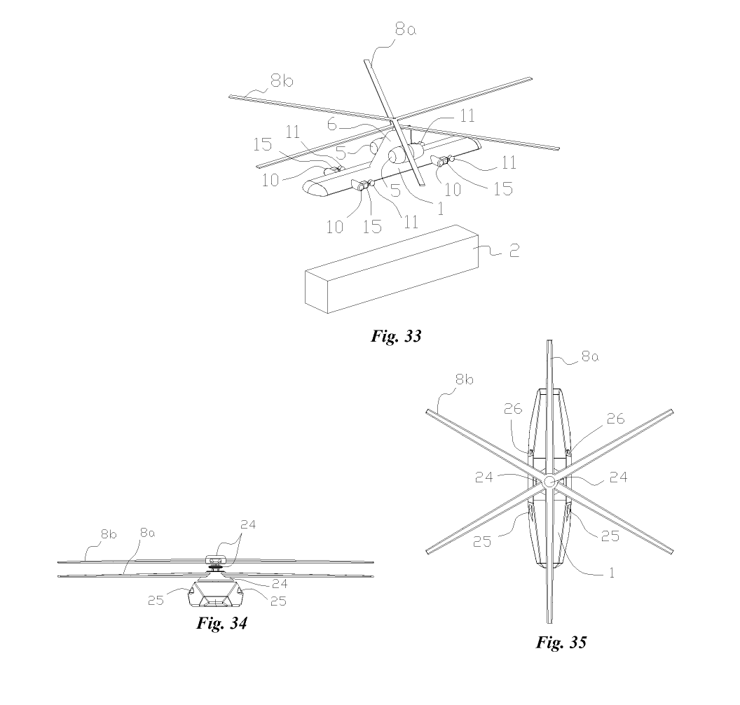

FIGS. 29-33 depict yet a further embodiment of the drone cargo aircraft comprising a plurality of telescoping struts 15. The telescoping struts 15 are coupled to elongated body 1, preferably at the opposing sides, via either a fixed or pivot joint 10. In a first position, the telescoping struts 15 are deployed for landing and/or ground transportation. In a second position, the telescoping struts 15 are retracted for flight. In a further alternative embodiment depicted in FIGS. 31-33, the telescoping struts 15 are coupled to the elongated body 1 via a pivot joint 10 permitting the retracted telescoping struts 15 to pivot approximately 90 degree. The cargo helicopter may couple the container 2 by landing directly onto the container 2 with the retracted telescoping struts 15 pivoted alongside the elongated body. Similarly, a loaded cargo helicopter may disengage from the container 2 and take flight away from the container 2.

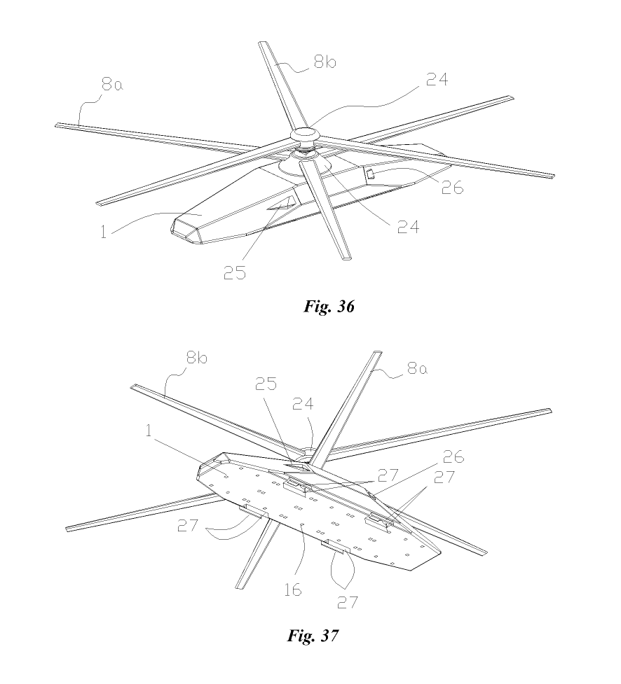

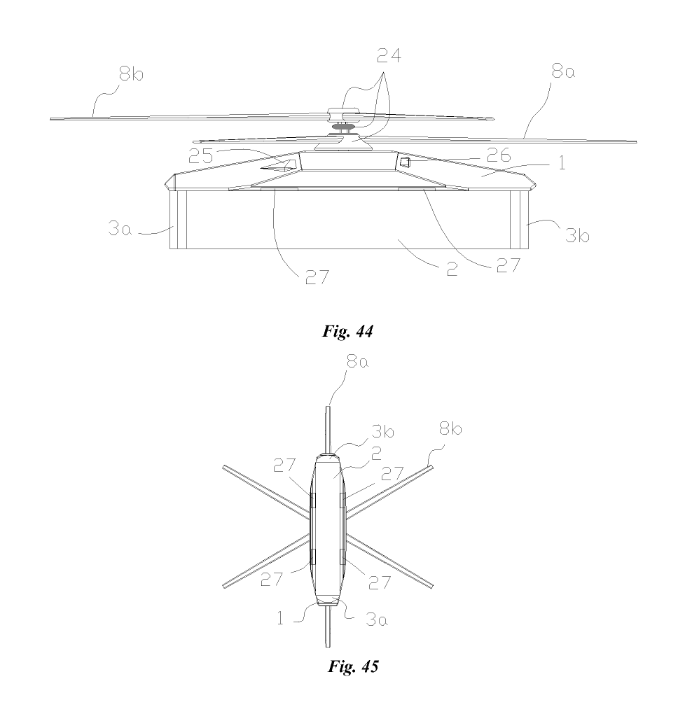

FIGS. 34-45 depict an embodiment of a stealth cargo helicopter. The helicopter depicted herein comprise coaxial counter-rotating blades 8a, 8b and associated hub fairings 24 to reduce the noise and radar reflection of the hub. Engine air intakes 25 and air exhausts may be disposed along the upper surface of opposing sides of the elongated beam 1. In the embodiment depicted in FIGS. 34-45, the air intakes 25 and air exhausts 26 are disposed along the opposing sides of the elongated body 1.

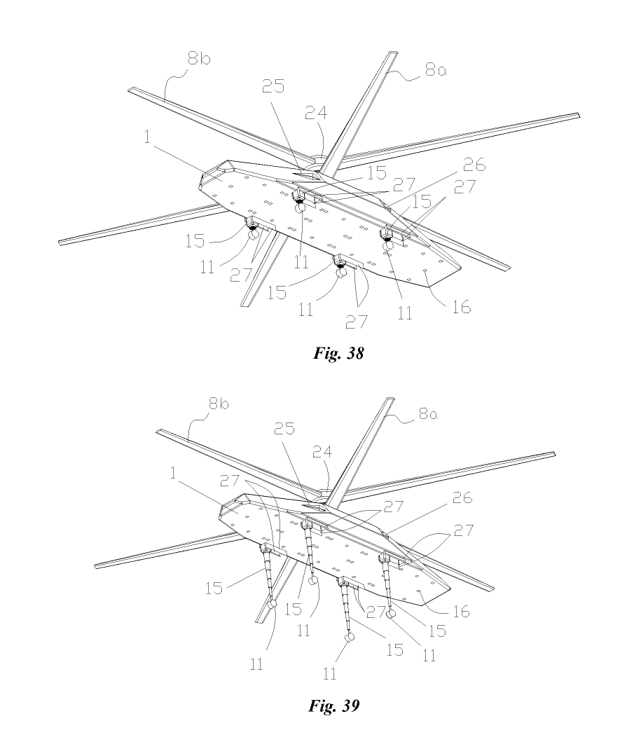

FIGS. 37-39 depict the deployment of the telescoping struts 15 or landing gear while the stealth cargo helicopter is in flight. The landing gear doors 27 disposed on the lower surface of the elongated body 1 open (FIG. 37) and the retracted telescoping struts 15 pivot out of the landing gear cavity disposed between the lower and upper surfaces of the elongated body 1 (FIG. 38). Once the telescoping struts 15 are deployed and extended (FIG. 39), the stealth cargo helicopter is ready for landing and/or ground transportation. Due to the fact that the telescoping struts 15 are stored in the landing gear cavity disposed between the upper and lower surfaces of the elongated body 1, it is understood that the elongated body 1 of the stealth cargo helicopter will have a width that is greater than the container(s) supported by it.

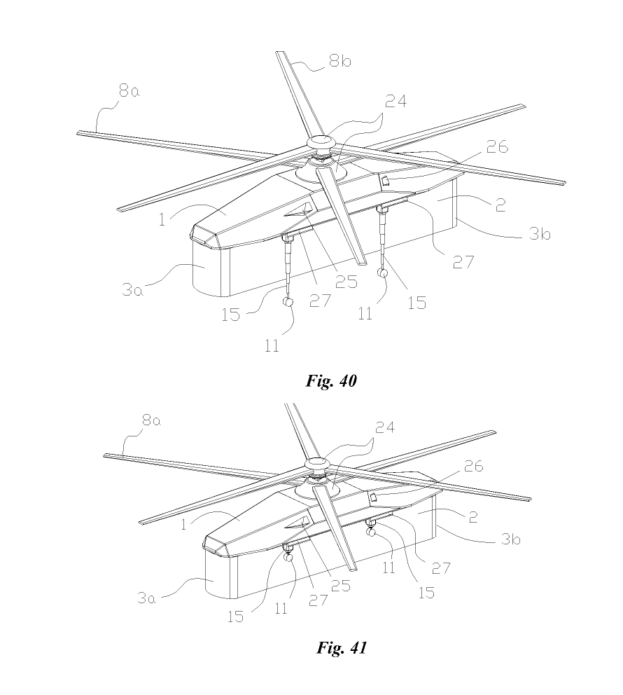

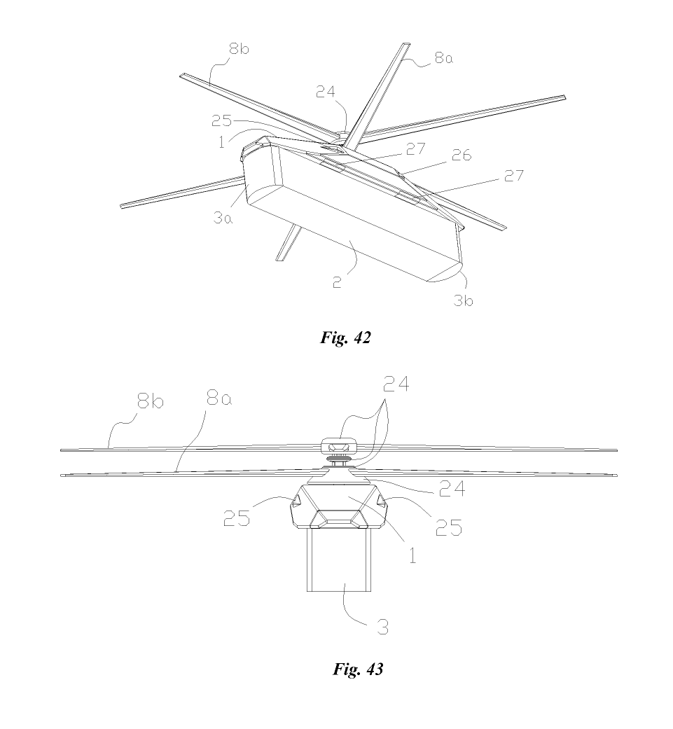

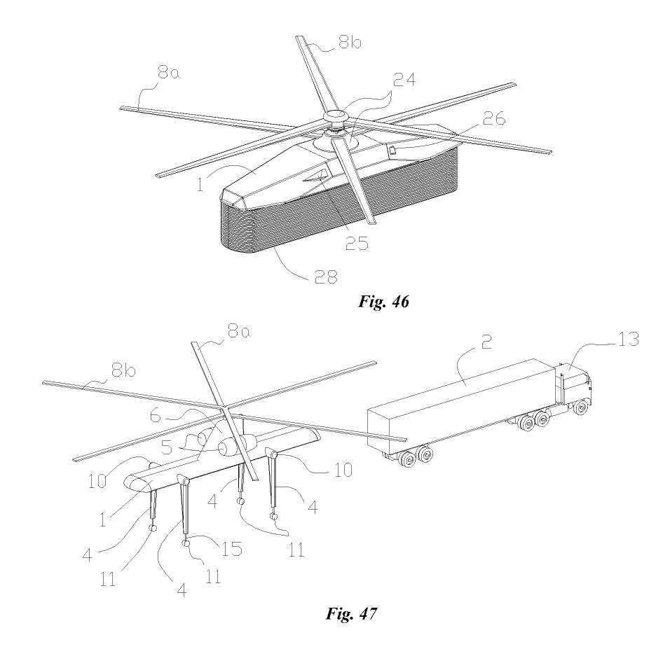

FIGS. 40-45 depict the retraction of the telescoping struts 15 for take-off. A container 2 is rigidly coupled to the lower surface of the elongated beam 1 such that the elongated beam 1 and the container 2 constitute a single integrated unit (FIG. 40). The telescoping struts 15 are retracted upwards (FIG. 41) and once pivoted into the landing gear cavity, the landing gear doors closed (FIG. 42). As depicted in FIG. 43-45, the main structural elements exposed on the stealth cargo helicopter are the counter-rotating blades and the elongated body 1. As shown in FIG. 46, an optional anti-radar skirt 28 may further be provided.

In a preferred embodiment, the struts or the struts are only strong enough to support the helicopter without the container and thereby providing an opportunity to reduce the overall weight of the cargo helicopter. Thus, the struts would only be sufficient to maneuver the cargo helicopter over the container, lower the elongated body 1 onto the container or alternatively lift the container on a support onto the lower surface of the elongated body 1, upon which the cargo helicopter may take off for flight.

Upon landing, the container would be the structure that first makes contact with the ground surface, with the struts being retracted. The container 2 would then be decouple from the elongated body and the cargo helicopter may then take flight. Alternatively, the struts may deploy just prior to landing but compress such that it shares the landing load with the container. The cargo helicopter would then decouple from the container and either take off or roll away from the container prior to taking off or rolling away from the container prior to taking off again or coupling with another container.

In all of the embodiments described herein, the struts 4 and/or the telescoping struts 15 has the capability of lowering the elongated body 1 closer to the ground in order to permit ease of maintenance. The height of each one of the struts 4 and/or telescoping struts 15 may be independently adjusted to permit coupling of the elongated body 1 to a container that is supported on an uneven surface. Thus, in an instance where the container is facing an incline, the forward struts 4 and/or telescoping struts 15 may be provided at a relatively smaller length as compared to the aft struts 4 and/r telescoping struts 15 such that the lower surface of the elongated body 1 is substantially parallel to the upper surface of the container.

Reference is made to U.S. Pat. No. 7,261,257, issued Aug. 28, 2007, U.S. Pub. No. 2010/0276538, published Nov. 4, 2010 and U.S. Pub. No. 2010/0308180, published Dec. 9, 2010, the entire contents of each of which are incorporated by reference as if fully set forth herein.

The invention described and claimed herein is not to be limited in scope by the specific preferred embodiments disclosed herein, as these embodiments are intended as illustrations of several aspects of the invention. Indeed, various modifications of the invention in addition to those shown and described herein will become apparent to those skilled in the art from the foregoing description. Such modifications are also intended to fall within the scope of the appended claims.

What is claimed is:

1. A drone cargo helicopter comprising:
an elongated body having a low profile and comprising a front portion, a rear portion, an upper surface, a lower surface and a pair of opposing sides extending between the front and the rear portions;
at least a first blade set coupled to the upper surface and rotating in a first direction; and
two or more struts pivotally coupled to opposing sides or lower surface of the elongated body, the struts being coupled to the elongated body via a joint at a top end of the strut;
wherein the lower surface of the elongated body comprises a substantially planar surface between the front and rear portions, the substantially planar surface having one or more attachments to provide a rigid and fixed engagement with a container;
wherein the struts are pivotally movable between a first position and a second position; and
wherein in the first position, the struts support the elongated body a distance from a ground surface that is greater than a height of the container.

2. The drone cargo helicopter of claim 1, further comprising a second blade set coupled to the upper surface of the elongated body, the second blade set rotating in a second direction that opposes the first direction of the first blade set.

3. The drone cargo helicopter of claim 2, wherein the first and second blade sets are positioned on the elongated body in a side-by-side configuration and have separate axes of rotation.

4. The drone cargo helicopter of claim 2, wherein the first and second blade sets are stacked and share a single axis of rotation.

5. The drone cargo helicopter of claim 1, wherein the struts each further comprises a wheel coupled to a bottom end of the strut.

6. The drone cargo helicopter of claim 5, wherein the struts each further comprises a hydraulic piston to adjust the distance of the elongated body from the ground surface when the struts are in the first position between a first distance that is greater than the height of the container and a second distance that is equal to or less than the height of the container.

7. The drone cargo helicopter of claim 1, wherein in the second position, the struts are substantially positioned adjacent and substantially parallel to the sides of the elongated body.

8. The drone cargo helicopter of claim 1, further comprising a fuel tank disposed within the elongated body.

9. The drone cargo helicopter of claim 1, further comprising a fuel tank disposed externally of the elongated body.

10. The drone cargo helicopter of claim 1, wherein the attachments provide the rigid engagement between the elongated body and the container along at least four substantially opposing corners of the elongated body.

11. The drone cargo helicopter of claim 1 further comprising one or both of a forward fairing and an aft fairing coupled to the elongated body at the front portion and the rear portion, respectively.

12. A drone cargo helicopter comprising:
an elongated body comprising a front portion, a rear portion, an upper surface, a lower surface and a pair of opposing sides extending between the front and the rear portions;
at least a first blade set coupled to the upper surface, the first blade set rotating in a first direction; and
two or more telescoping struts coupled to the elongated body, the struts configured to be actuated between a first extended configuration a second retracted configuration;
wherein in the first extended configuration, the elongated body is supported at a distance above the ground surface; and
wherein the lower surface of the elongated body comprises a substantially planar surface between the front and rear portions, the substantially planar surface having one or more attachments to provide a rigid engagement with a container.

13. The drone cargo helicopter of claim 12, wherein the struts are coupled to either the opposing sides of the elongated body or the lower surface of the elongated body.

14. The drone cargo helicopter of claim 12, wherein in the first extended position, the struts support the elongated body at a distance from the ground that is greater than a height of the container.

15. The drone cargo helicopter of claim 12, wherein joints couple the struts to the elongated body, the joints actuating the struts between a first position for actuation of the struts to the first extended configuration and a second position to substantially position the retracted strut adjacent to and substantially parallel the sides of the elongated body for flight.

16. The drone cargo helicopter of claim 15, wherein the elongated body further comprises an internal cavity between the upper and lower surface of the elongated body and wherein the struts are retracted into the internal cavity after or simultaneously with actuating the struts to a second position.

17. The drone cargo helicopter of claim 12 further comprising one or both of a forward fairing and an aft fairing coupled to the elongated body at the front portion and the rear portion, respectively.

18. The drone cargo helicopter of claim 12, further comprising a deployable anti-radar skirt that is configured to cover the peripheral surfaces of a container attached to the elongated body.

19. A drone cargo helicopter comprising:
an elongated body comprising a front portion, a rear portion, an upper surface, a lower surface and a pair of opposing sides extending between the front and the rear portions, wherein the lower surface comprises a substantially planar attachment area between the front and rear portions configured to rigidly attach a container;
at least two blades coupled to the upper surface, the two blades rotating in opposing directions; and
two or more struts coupled to either one of the lower surface or the opposing sides of the elongated body, the struts being actuated between a first position and a second position, wherein in the first position, the struts support the elongated body above a ground surface to receive a couple one or more containers and wherein in the second position, the struts are either telescopically retracted or pivotally positioned adjacent to and substantially parallel to the sides of the elongated body.

20. A drone cargo helicopter wherein the attachment area comprises attachments configured attach the container along at least four corners of the attachment area.
